(19) United States
(12) Patent Application Publication
(10) Pub. No.: US 2025/0218065 A1
(43) Pub. Date: Jul. 3, 2025

(54) INFORMATION PROCESSING APPARATUS AND INFORMATION PROCESSING METHOD

(71) Applicant: SONY HONDA MOBILTY INC., Tokyo (JP)

(72) Inventors: Ryosuke Nakayama, Tokyo (JP); Daisuke Kawamura, Tokyo (JP); Hisashi Murayama, Tokyo (JP)

(73) Assignee: SONY HONDA MOBILTY INC., Tokyo (JP)

(21) Appl. No.: 19/002,740

(22) Filed: Dec. 27, 2024

(30) Foreign Application Priority Data
Dec. 27, 2023 (JP) 2023-221656

(51) Int. Cl. G06T 11/00; G08G 1/16

(52) U.S. Cl. CPC G06T 11/001; G08G 1/16

(57) ABSTRACT

The content of driving assistance is presented in an understandable manner. An information processing apparatus includes a display control section that controls display of a driving assistance image obtained by adding, to an image indicating a state of a periphery of a vehicle, assistance information that is added to an object within the image and assists driving, and controls a color and a shape of the assistance information based on a state of the object with respect to the vehicle.

The present technology can be applied to, for example, a vehicle.

### CROSS-REFERENCE TO RELATED APPLICATIONS

This application is based on and claims priority under 35 USC 119 from Japanese Patent Application No. 2023-221656 filed on Dec. 27, 2023, the entire content of which is incorporated herein by reference.

### BACKGROUND OF THE INVENTION

### Field of the Invention

The present technology relates to an information processing apparatus and an information processing method, and particularly relates to an information processing apparatus and an information processing method capable of presenting the content of driving assistance in an understandable manner.

### Description of the Related Art

In related art, a technology of displaying an object within an image of a periphery of an own vehicle by the object being enclosed within a frame having a size or a thickness in accordance with a degree of collision risk has been proposed (see, for example, International Publication No. WO 2013/118191).

As described in International Publication No. WO 2013/118191, in a case where driving is assisted using an image, it is desired to present the content of the driving assistance in an understandable manner.

The present technology has been made in view of such circumstances and is directed to being able to present the content of driving assistance in an understandable manner.

### SUMMARY OF THE INVENTION

An information processing apparatus according to a first aspect of the present technology includes a display control section that controls display of a driving assistance image obtained by adding, to an image indicating a state of a periphery of a vehicle, assistance information that is added to an object within the image and assists driving, and controls a color and a shape of the assistance information based on a state of the object with respect to the vehicle.

An information processing method according to a second aspect of the present technology includes an information processing apparatus controlling display of a driving assistance image obtained by adding, to an image indicating a state of a periphery of a vehicle, assistance information for an object around the vehicle, and controlling a color and a shape of the assistance information based on a state of the object with respect to the vehicle.

An information processing apparatus according to a second aspect of the present technology includes a display control section that controls display of a driving assistance image obtained by adding, to an image indicating a state of a periphery of a vehicle, assistance information grounded or displayed on the ground for assisting driving.

An information processing method according to a second aspect of the present technology includes an information processing apparatus controlling display of a driving assistance image obtained by adding, to an image indicating a state of a periphery of a vehicle, assistance information grounded or displayed on the ground within the image for assisting driving.

In the first aspect of the present technology, display of the driving assistance image obtained by adding, to the image indicating the state of the periphery of the vehicle, the assistance information that is added to the object within the image and assists driving is controlled, and the color and the shape of the assistance information are controlled based on the state of the object with respect to the vehicle.

In the second aspect of the present technology, display of the driving assistance image obtained by adding, to the image indicating the state of the periphery of the vehicle, the assistance information grounded or displayed on the ground within the image for assisting driving is controlled.

### BRIEF DESCRIPTION OF THE DRAWINGS

FIG. 1 is a block diagram illustrating a configuration example of functions of a vehicle to which the present technology is applied;

FIG. 2 is a schematic view illustrating an arrangement example of some of the functions of the vehicle in FIG. 1;

FIG. 3 is a view schematically illustrating a portion around a dashboard in a front portion inside the vehicle;

FIG. 4 is a block diagram illustrating a configuration example of functions to be implemented by a control unit of the vehicle;

FIG. 5 is a flowchart for explaining driving assistance image display processing to be executed by the vehicle;

FIG. 6 is a schematic view illustrating a specific example of a driving assistance image;

FIG. 7 is a schematic view illustrating a specific example of the driving assistance image;

FIG. 8 is a schematic view illustrating a specific example of the driving assistance image;

FIG. 9 is a view indicating an example of specifications of the color of an outline;

FIG. 10 is a schematic view illustrating a specific example of the driving assistance image;

FIG. 11 is a schematic view illustrating a specific example of the driving assistance image;

FIG. 12 is a schematic view illustrating a specific example of the driving assistance image;

FIG. 13 is a schematic view illustrating a specific example of the driving assistance image;

FIG. 14 is a schematic view illustrating a specific example of the driving assistance image;

FIG. 15 is a schematic view illustrating a specific example of the driving assistance image;

FIG. 16 is a schematic view illustrating a specific example of the driving assistance image;

FIG. 17 is a schematic view illustrating a specific example of the driving assistance image; and

FIG. 18 is a block diagram illustrating a configuration example of a computer.

### DETAILED DESCRIPTION OF THE INVENTION

An embodiment of the present technology will be described below. The description will be provided in the following order.
1. Embodiment
2. Modifications
3. Others

### 1. Embodiment

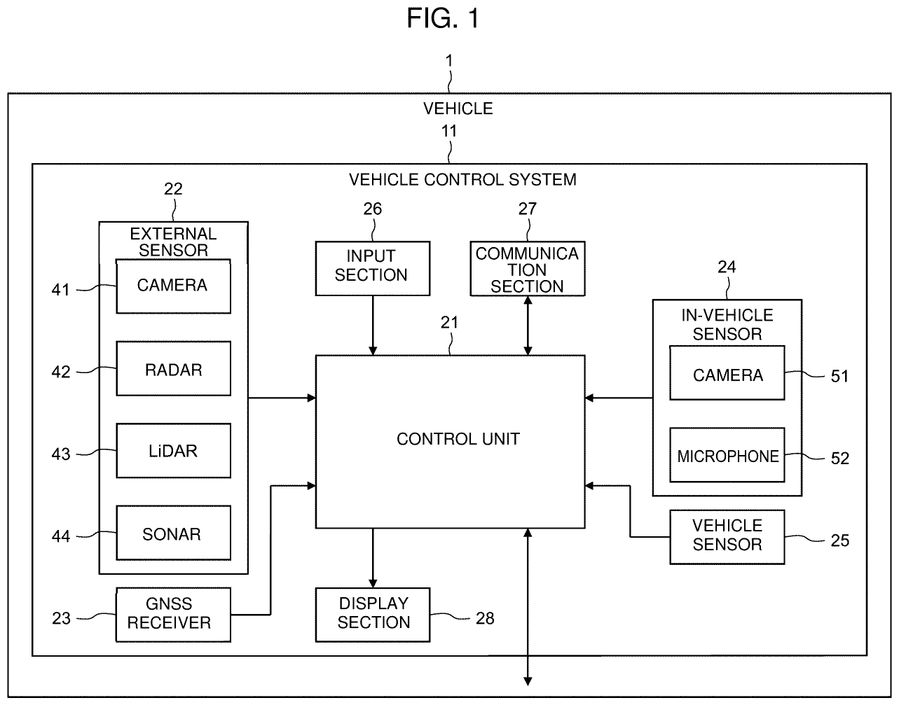

An embodiment of the present technology will be described with reference to FIG. 1 to FIG. 17.

### <Configuration Example of Vehicle 1>

FIG. 1 illustrates a configuration example of functions mainly related to the present technology among functions of a vehicle 1 to which the present technology is applied.

The vehicle 1 includes a vehicle control system 11. The vehicle control system 11 includes a control unit 21, an external sensor 22, a global navigation satellite system (GNSS) receiver 23, an in-vehicle sensor 24, a vehicle sensor 25, an input section 26, a communication section 27 and a display section 28.

The control unit 21 includes one or a plurality of electronic control units (ECUs). The control unit 21 executes various kinds of processing and control of the respective sections of the vehicle 1.

The external sensor 22 includes various kinds of sensors to be used for detection of various kinds of information of an outer world (external world) of the vehicle 1 and supplies sensor data from each sensor to the control unit 21. Types and the number of sensors provided in the external sensor 22 are not particularly limited.

For example, the external sensor 22 includes a camera 41, a radar 42, a LiDAR 43, and a sonar 44. Types and the number of the camera 41, the radar 42, the LiDAR 43 and the sonar 44 are not particularly limited.

For example, an imaging scheme of the camera 41 is not particularly limited. For example, cameras employing various kinds of imaging schemes, such as a time of flight (ToF) camera, a stereo camera, a monocular camera, and an infrared camera which employ imaging schemes capable of measuring a distance, are applied to the camera 41 as necessary. The camera 41 is not limited to these and may be a camera for simply acquiring a captured image without involving distance measurement.

The GNSS receiver 23 receives a GNSS signal from a GNSS satellite and supplies the GNSS signal to the control unit 21.

The in-vehicle sensor 24 includes various kinds of sensors to be used for detection of various kinds of information within the vehicle and supplies sensor data from each sensor to the control unit 21. Types and the number of sensors provided in the in-vehicle sensor 24 are not particularly limited.

For example, the in-vehicle sensor 24 includes a camera 51 and a microphone 52. Types and the number of the camera 51 and the microphone 52 are not particularly limited. Further, an imaging scheme of the camera 51 is not particularly limited as with the camera 41 of the external sensor 22.

The vehicle sensor 25 includes various kinds of sensors to be used for detection of a state of the vehicle 1 and supplies sensor data from each sensor to the control unit 21. Types and the number of sensors provided in the vehicle sensor 25 are not particularly limited.

For example, the vehicle sensor 25 includes a speed sensor, an acceleration sensor, an angular velocity sensor (gyro sensor) and an inertial measurement unit (IMU) in which these are integrated. For example, the vehicle sensor 25 includes a steering angle sensor that detects a steering angle of a steering wheel, a yaw rate sensor, an accelerator sensor that detects an operation amount of an accelerator pedal, and a brake sensor that detects an operation amount of a brake pedal. For example, the vehicle sensor 25 includes a rotation sensor that detects an engine speed and a rotation speed of a motor, a pneumatic sensor that detects a pneumatic pressure of a tire, a slip ratio sensor that detects a slip ratio of a tire and a wheel speed sensor that detects a rotation speed of a wheel. For example, the vehicle sensor 25 includes a battery sensor that detects a remaining amount and a temperature of a battery and a shock sensor that detects a shock from outside.

The input section 26 includes an input device that allows an occupant to input data, an instruction, or the like, generates an input signal based on the data, the instruction, or the like, input through the input device and supplies the input signal to the control unit 21. For example, the input section 26 may include an input device that allows the occupant to input an instruction, or the like, through speech or gesture as well as an input device that allows the occupant to input data, an instruction, or the like, by directly operating the input device.

The communication section 27 includes various kinds of communication devices, performs communication with various kinds of equipment inside and outside the vehicle, other vehicles, a server, a base station, and the like, and transmits/receives various kinds of data. The communication section 27 can perform communication using a plurality of communication schemes as necessary.

The display section 28 includes various kinds of display devices and displays visual information. The number and types of the display devices provided in the display section 28 are not particularly limited. As the display device provided in the display section 28, for example, a display device that presents visual information by displaying an image on itself, or a projector device that presents visual information by projecting an image can be applied. Note that the display device may be a device that displays visual information within a field of view of a user, such as, for example, a head-up display, a transparent display, and a wearable device having an augmented reality (AR) function, as well as a display device including a normal display.

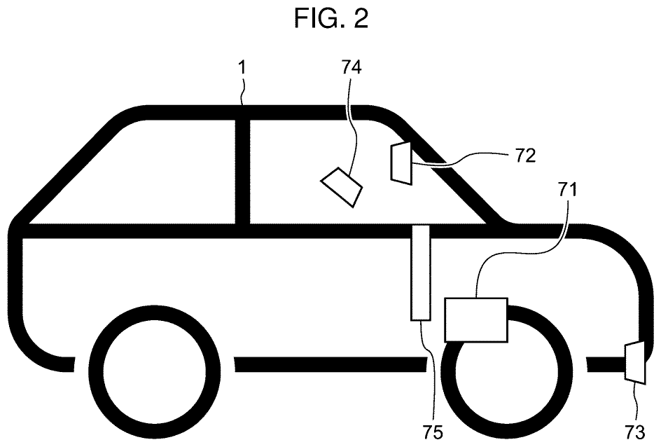

FIG. 2 schematically illustrates an arrangement example of some of the functions of the vehicle 1 in FIG. 1.

The vehicle 1 includes an ECU 71, a front sensing unit 72, a sonar 73, a ToF camera 74, and a display unit 75.

The ECU 71, which, for example, constitutes part of the control unit 21 in FIG. 1, is provided in a front portion of the vehicle 1.

The front sensing unit 72, which, for example, constitutes part of the external sensor 22 in FIG. 1, is provided in a front portion of the vehicle 1. The front sensing unit 72, which includes, for example, part of the camera 41, the radar 42 and the LiDAR 43 of the external sensor 22, performs sensing ahead of the vehicle 1.

The sonar 73, which, for example, constitutes part of the sonar 44 of the external sensor 22 in FIG. 1, is provided in a front and lower portion of the vehicle 1. The sonar 73 performs sensing near a road surface ahead of the vehicle 1.

The ToF camera 74, which, for example, constitutes part of the camera 51 of the in-vehicle sensor 24 in FIG. 1, is provided on a dashboard of the vehicle 1. The ToF camera 74 captures an image of an occupant (for example, a driver) in the vehicle.

The display unit 75, which, for example, constitutes part of the display section 28 in FIG. 1, is provided on a front surface of the dashboard of the vehicle 1.

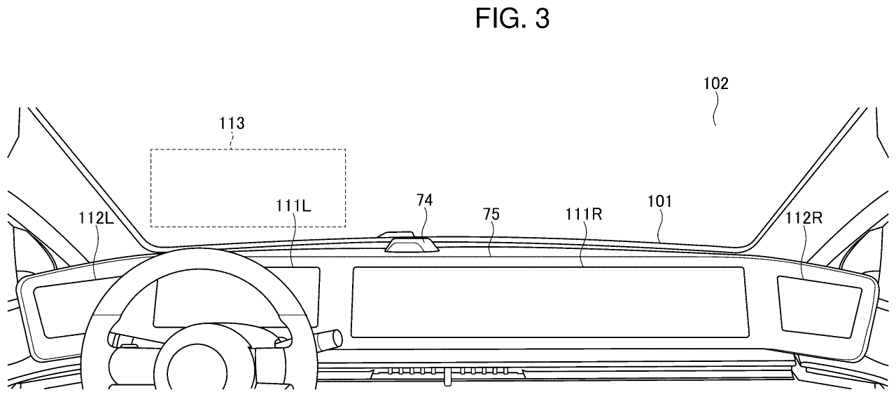

FIG. 3 schematically illustrates a portion around the dashboard 101 in the front portion inside the vehicle 1.

Around the dashboard 101, the ToF camera 74, the display unit 75, and the head-up display (only the display 113 is illustrated) are provided.

The ToF camera 74 is provided slightly closer to a driver's seat from the center in a left-right direction on the dashboard 101. The ToF camera 74, for example, captures an image of a range including at least the head of the driver seated on the driver's seat.

The display unit 75 is provided in front of the driver's seat and a front passenger's seat below a windshield 102 so as to extend on the front surface of the dashboard 101 in a horizontal direction. The display unit 75 has a configuration in which a display 111L, a display 111R, a display 112L and a display 112R are continuous in the left-right direction and are integrated. The display 111L, the display 111R, the display 112L and the display 112R can respectively independently perform display or can perform display in an integrated manner.

The display 111L and the display 111R extend leftward and rightward from a portion near a left end of the driver's seat to a portion near a right end of the front passenger's seat in front of the driver's seat and the front passenger's seat below the windshield 102 and face backward (toward the back portion of the vehicle 1) viewed from the driver's seat or the front passenger's seat. The display 111L is disposed in front of the driver's seat. The display 111R is disposed at a portion between the driver's seat and the front passenger's seat and in front of the front passenger's seat.

The display 112L and the display 112R are provided substantially symmetrically at both left and right ends of the display unit 75. The display 112L tilts inward of the vehicle with respect to the display 111L at the left end of the display unit 75 and faces diagonally backward right (toward the diagonally backward right portion of the vehicle 1) viewed from the driver's seat or the front passenger's seat. The display 112R tilts inward of the vehicle with respect to the display 111R at the right end of the display unit 75 and faces diagonally backward left (toward the diagonally backward left portion of the vehicle 1) viewed from the driver's seat or the front passenger's seat.

The display 111L and the display 111R, for example, display information that assists driving, an image of a periphery of the vehicle 1, information related to infotainment, and the like. For example, information mainly for the driver is displayed on the display 111L. For example, information related to infotainment such as audio, a video, a website, a map, and the like, is displayed on the display 111R.

Further, as will be described later, a driving assistance image is displayed on the display 111L. The driving assistance image is, for example, an image obtained by adding assistance information that assists driving to an image indicating a state of a periphery (for example, ahead) of the vehicle 1.

The display 112L and the display 112R are mainly used as a digital outer mirror (electronic side mirror) that is a substitute for a side mirror in the related art. In other words, the display 112L and the display 112R are used for a camera monitoring system (CMS). For example, the display 112L displays an image of a portion diagonally backward left of the vehicle 1 captured by the camera 41. The display 112R displays an image of a portion diagonally backward right of the vehicle 1 captured by the camera 41.

The head-up display includes a display 113 (hereinafter, referred to as an HUD display 113) provided in front of the driver's seat. For example, the HUD display 113 may be constituted with part of the windshield 102 or may be provided separately from the windshield 102. In the latter case, for example, the HUD display 113 is pasted on the windshield 102. Then, as a result of visual information being projected on the HUD display 113 using an AR technology, the visual information is superimposed within the field of view of the driver.

The HUD display 113 displays, for example, information that assists driving.

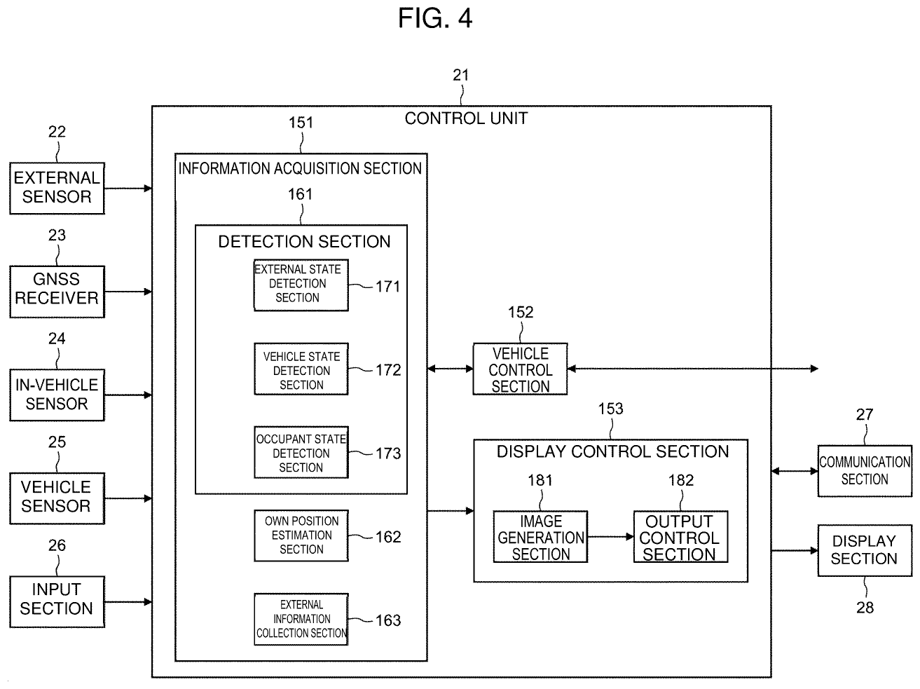

FIG. 4 illustrates a configuration example of functions to be implemented by the control unit 21. The control unit 21 includes an information acquisition section 151, a vehicle control section 152, and a display control section 153. The information acquisition section 151 includes a detection section 161, an own position estimation section 162, and an external information collection section 163. The detection section 161 includes an external state detection section 171, a vehicle state detection section 172 and an occupant state detection section 173.

The external state detection section 171 executes detection processing of an external state based on sensor data from the external sensor 22. For example, the external state detection section 171 detects or estimates whether or not there is an object around the vehicle 1, a contour, a size, a shape, a position, motion, an attribute (such as a type), and the like, of the object around the vehicle 1. The object around the vehicle 1 includes, for example, another vehicle, a person, a bicycle, an obstacle, a structure, a road, a traffic light, a traffic sign, a road sign, and the like. The external state detection section 171, for example, detects or estimates an environment around the vehicle 1. The environment around the vehicle 1 includes, for example, weather, a temperature, a humidity, brightness, a state of a road surface, and the like. The external state detection section 171 supplies information indicating a result of the detection processing to the vehicle control section 152 and the display control section 153.

The vehicle state detection section 172 executes detection processing of a state of the vehicle 1 based on the sensor data from the vehicle sensor 25 and the information from the vehicle control section 152. For example, the vehicle state detection section 172 detects or estimates a traveling state of the vehicle 1, states of the respective sections of the vehicle 1, an operating state of automated driving of the vehicle 1, and the like. The vehicle state detection section 172 supplies information indicating a result of the detection processing to the vehicle control section 152 and the display control section 153.

The occupant state detection section 173 executes detection processing of a state of the occupant based on the sensor data from the in-vehicle sensor 24. For example, the occupant state detection section 173 detects or estimates a posture and a gaze direction of the occupant. The posture of the occupant includes, for example, a direction of the face of the occupant, a position of the face and positions of the eyes. For example, the occupant state detection section 173 detects or estimates a physical condition, a degree of alertness, a degree of concentration, a degree of fatigue, a degree of drunkenness, driving operation, and the like, of the occupant. For example, the occupant state detection section 173 recognizes gestures and the content of utterances of the occupant. The occupant state detection section 173 supplies information indicating a result of the detection processing to the vehicle control section 152 and the display control section 153.

The own position estimation section 162 estimates an own position of the vehicle 1 based on the GNSS signal from the GNSS receiver 23. The own position estimation section 162 supplies information indicating the estimation result to the vehicle control section 152 and the display control section 153.

Note that the own position estimation section 162 may estimate the own position of the vehicle 1 using other technologies such as simultaneous localization and mapping (SLAM).

The external information collection section 163 performs communication with various kinds of equipment inside and outside the vehicle, other vehicles, a server, a base station, or the like, via the communication section 27 to collect external information regarding the external world of the vehicle 1. The external information includes, for example, map information, traffic information, weather information, and information on the periphery of the vehicle 1. The information on the periphery of the vehicle 1 includes, for example, sightseeing information, information on various kinds of facilities such as commercial facilities, and the like. The external information collection section 163 supplies the collected external information to the vehicle control section 152 and the display control section 153.

The vehicle control section 152 executes control of the respective sections of the vehicle 1 based on the various kinds of information supplied from the information acquisition section 151, the input signal from the input section 26, and the like. For example, the vehicle control section 152 executes control of a steering system, a brake system, a drive system, a body-related system, various kinds of lights, a car horn, and the like, of the vehicle 1. For example, the vehicle control section 152 executes control of automated driving (driving assistance) of level 1 to level 5 of the vehicle 1. The vehicle control section 152 supplies information indicating the state of the vehicle 1 to the information acquisition section 151 based on the control state of the vehicle 1.

The display control section 153 controls display of various kinds of display images by the display section 28. The display control section 153 includes an image generation section 181 and an output control section 182.

The image generation section 181 generates a display image to be displayed on the display section 28 based on various kinds of information supplied from the information acquisition section 151 and the input signal from the input section 26, and the like. The display image includes the driving assistance image described above. The image generation section 181 supplies the display image to the output control section 182.

The output control section 182 controls display of the display image by a display device provided in the display section 28 by controlling output of the display image to the display device.

### <Driving Assistance Image Display Processing>

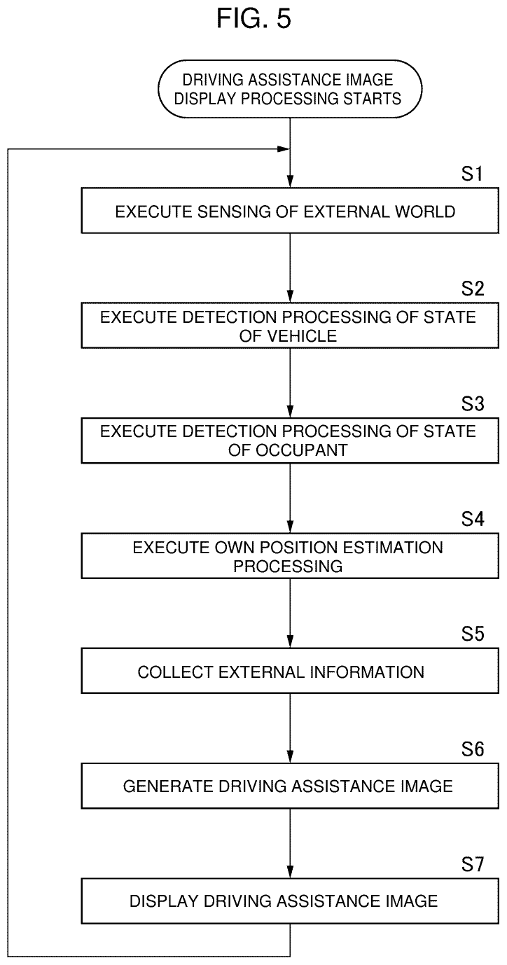

Driving assistance image display processing to be executed by the vehicle 1 will be described next with reference to the flowchart in FIG. 5.

This processing is, for example, started when the occupant gives an instruction to display the driving assistance image via the input section 26 and ends when the occupant gives an instruction to stop display of the driving assistance image.

In step S1, the vehicle 1 executes sensing of the external world. Specifically, each sensor of the external sensor 22 executes sensing of the external world and supplies sensor data obtained through the sensing to the control unit 21. The external state detection section 171 of the control unit 21 executes detection processing of a state of the external world based on the sensor data from the external sensor 22. The external state detection section 171 supplies information indicating a result of the detection processing to the vehicle control section 152 and the display control section 153.

In step S2, the vehicle 1 executes detection processing of a state of the vehicle 1. Specifically, each sensor of the vehicle sensor 25 detects the state of the vehicle 1 and supplies sensor data indicating the detection result to the control unit 21. The vehicle control section 152 supplies information indicating states of the respective sections of the vehicle 1 to the control unit 21. The vehicle state detection section 172 of the control unit 21 executes detection processing of the state of the vehicle 1 based on the sensor data from the vehicle sensor 25 and the information from the vehicle control section 152. The vehicle state detection section 172 supplies information indicating a result of the detection processing to the vehicle control section 152 and the display control section 153.

In step S3, the vehicle 1 executes detection processing of a state of the occupant. Specifically, the in-vehicle sensor 24 executes sensing of inside of the vehicle and supplies sensor data obtained through the sensing to the control unit 21. The occupant state detection section 173 of the control unit 21 executes detection processing of a state of the occupant based on the sensor data from the in-vehicle sensor 24. The occupant state detection section 173 supplies information indicating a result of the detection processing to the vehicle control section 152 and the display control section 153.

In step S4, the vehicle 1 executes own position estimation processing. Specifically, the GNSS receiver 23 receives a GNSS signal from the GNSS satellite and supplies the GNSS signal to the control unit 21. The own position estimation section 162 estimates an own position of the vehicle 1 based on the GNSS signal. The own position estimation section 162 supplies information indicating the estimation result to the vehicle control section 152 and the display control section 153.

In step S5, the vehicle 1 collects external information. Specifically, the external information collection section 163 performs communication with an external server, or the like, via the communication section 27 to collect external information regarding the external world of the vehicle 1. The external information collection section 163 supplies the collected external information to the vehicle control section 152 and the display control section 153.

Note that the processing from step S1 to step S5 does not necessarily have to be executed in this order. For example, the processing order may be changed, or a plurality of kinds of processing may be executed in parallel. Further, in each loop of the driving assistance image display processing, all the processing from step S1 to step S5 does not necessarily have to be executed every time, and part of the processing may be omitted.

In step S6, the image generation section 181 generates the driving assistance image. For example, the image generation section 181 generates an image (hereinafter, referred to as a front image) indicating a state ahead of the vehicle 1 through computer graphics (CG) based on at least one or more among the result of the detection processing of the state of the external world, the result of the detection processing of the state of the vehicle 1, the result of the detection processing of the state of the occupant, the estimation result of the own position of the vehicle 1 and the external information.

Note that the front image may be an image that reproduces the state of the periphery of the vehicle 1 in detail or may be an image that reproduces the state of the periphery of the vehicle 1 in a simplified manner. Further, the front image includes, for example, an image indicating the vehicle 1 that is the own vehicle.

Further, for example, the image generation section 181 generates the driving assistance image by adding assistance information that assists driving to the front image by the CG based on at least one or more among the result of the detection processing of the state of the external world, the result of the detection processing of the state of the vehicle 1, the result of the detection processing of the state of the occupant, the estimation result of the own position of the vehicle 1, and the external information.

Further, for example, the image generation section 181 controls a display aspect of the assistance information based on at least one or more among the result of the detection processing of the state of the external world, the result of the detection processing of the state of the vehicle 1, the result of the detection processing of the state of the occupant, the estimation result of the own position of the vehicle 1, and the external information. For example, the image generation section 181 controls a display aspect of assistance information for an object within the driving assistance image based on a state of the object with respect to the vehicle 1. More specifically, for example, the image generation section 181 controls at least one of the color or the shape of the assistance information for the object within the driving assistance image based on at least one or a plurality of combinations of a distance from the object to the vehicle 1, a relative speed, a moving direction, other behaviors, and a size of the object.

The image generation section 181 supplies the driving assistance image to the output control section 182.

In step S7, the vehicle 1 displays the driving assistance image. Specifically, the output control section 182 supplies the driving assistance image to the display 111L. The display 111L displays the driving assistance image.

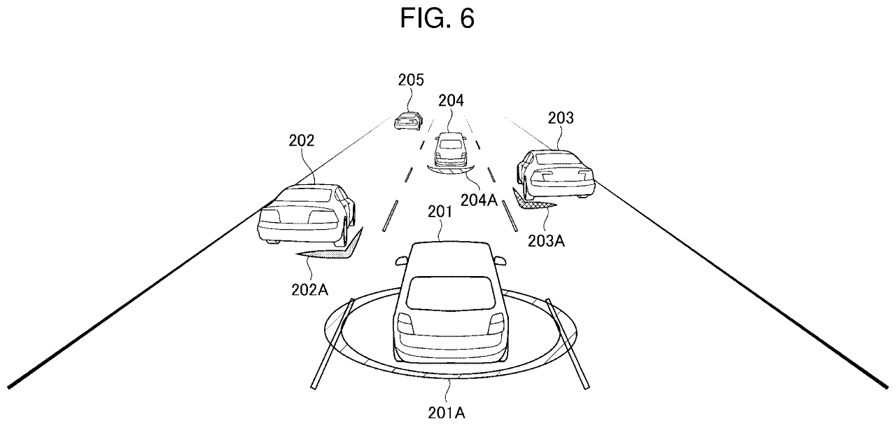

Note that specific examples of the driving assistance image will be described later with reference to FIG. 6 to FIG. 17.

Then, the processing returns to step S1, and the processing in step S1 and subsequent steps is executed.

### <Specific Examples of Driving Assistance Image>

Specific examples of the driving assistance image and the assistance information will be described next with reference to FIG. 6 to FIG. 17.

### <Display Examples of Assistance Information for Other Vehicles>

First, display examples of the assistance information for other vehicles will be described with reference to FIG. 6 to FIG. 8. FIG. 6 to FIG. 8 schematically illustrate examples of the driving assistance image.

In the driving assistance image in FIG. 6, vehicles 201 to 205 are displayed. The vehicle 201 is an image indicating the own vehicle (vehicle 1), and the vehicles 202 to 205 are images indicating other vehicles around the own vehicle.

The vehicles 201 to 205 are traveling in the same direction on a road including three lanes each way. The vehicles 201 and 204 are traveling on the center lane. The vehicles 202 and 205 are traveling on the left lane. The vehicle 203 is traveling on the right lane. Distances from the vehicle 201 to the vehicle 202, the vehicle 203, the vehicle 204 and the vehicle 205, are shorter in this order.

An outline 201A that is assistance information indicating a position of the vehicle 201 that is the own vehicle is displayed on a road surface around the vehicle 201. The outline 201A has a substantially elliptic shape and encloses the periphery of the vehicle 201. The color of the outline 201A is set at, for example, blue.

An outline 202A that is assistance information that calls attention for the vehicle 202 is displayed on a road surface around the vehicle 202. The outline 202A encloses in an L shape, a portion right backward of the vehicle 202 that is a portion close to the front surface (traveling direction) of the vehicle 201, that is, a portion with which the vehicle 201 is likely to come into collision or contact among the periphery of the vehicle 202. The color of the outline 202A is set at, for example, orange.

An outline 203A that is assistance information that calls attention for the vehicle 203 is displayed on a road surface around the vehicle 203. The outline 203A encloses in an L shape, a portion left backward of the vehicle 203 that is a portion close to the front surface (traveling direction) of the vehicle 201, that is, a portion with which the vehicle 201 is likely to come into collision or contact among the periphery of the vehicle 203. The color of the outline 203A is set at, for example, yellow.

An outline 204A that is assistance information that calls attention for the vehicle 204 is displayed on a road surface around the vehicle 204. The outline 204A is enclosed in a U shape, a portion backward of the vehicle 204 that is a portion close to the front surface (traveling direction) of the vehicle 201, that is, a portion with which the vehicle 201 is likely to come into collision or contact among the periphery of the vehicle 204. The color of the outline 204A is set at, for example, green.

The vehicle 205 is separate from the vehicle 201 by a distance equal to or greater than a predetermined distance, and thus, an outline is not particularly displayed around the vehicle 205.

Here, a display aspect (for example, the color and shape) of the outline for another vehicle (for example, the vehicles 202 to 205) changes depending on at least one of a relative position or movement with respect to the own vehicle (for example, the vehicle 201).

For example, the display aspect of the outline for another vehicle changes based on a moving direction of the other vehicle with respect to the own vehicle. More specifically, for example, in a case where movement of another vehicle in a direction (hereinafter, referred to as an interrupting direction) in which the other vehicle cuts into the traveling direction (for example, ahead) of the own vehicle is detected or estimated (predicted), the display aspect of the outline for the other vehicle changes.

For example, FIG. 6 to FIG. 8 illustrate change of the display aspect of the outline 202A in a case where the vehicle 202 tries to cut into the center lane from the left lane ahead of the vehicle 201.

Specifically, the vehicle 202 tries to change the lane from the left lane to the center lane on which the vehicle 201 is traveling, ahead of the vehicle 201. Thus, the vehicle 202 approaches the vehicle 201, and a risk of collision or contact increases.

In response to this, the shape of the outline 202A for the vehicle 202 changes so as to expand in the interrupting direction (direction of the lane to which the vehicle 202 changes the lane).

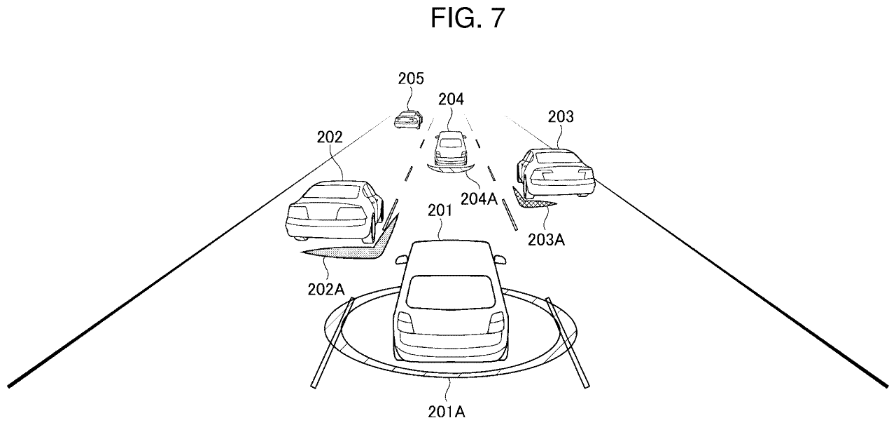

For example, in the example in FIG. 7, a right end of the vehicle 202 approaches a marking between the left lane and the center lane.

In response to this, a range of the outline 202A expands compared to the example in FIG. 6. Specifically, a range enclosing the portion right backward of the vehicle 202 in an L shape expands. In other words, the range of the outline 202A enclosing the vehicle 202 expands forward and leftward of the vehicle 202. Further, the outline 202A expands in the interrupting direction, that is, in a direction of the lane to which the vehicle 202 changes the lane.

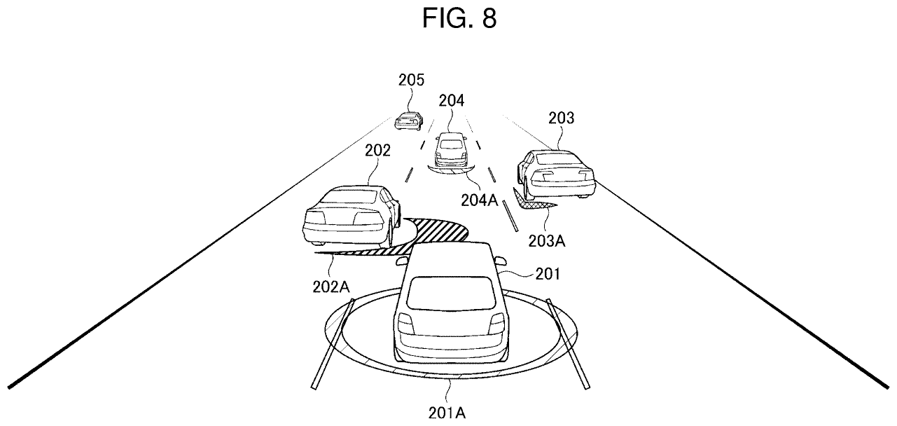

For example, in the example in FIG. 8, part of the vehicle 202 enters the center lane.

In response to this, the range of the outline 202A further expands compared to the example in FIG. 7. Specifically, the range enclosing a portion right backward of the vehicle 202 in the L shape further expands. In other words, the range of the outline 202A enclosing the vehicle 202 further expands forward and leftward of the vehicle 202. Further, the outline 202A further expands in the interrupting direction, that is, in the direction of the lane to which the vehicle 202 changes the lane.

Further, as the vehicle 202 approaches the vehicle 201 and becomes more likely to come into collision or contact with the vehicle 201, for example, the color of the outline 202A changes to a color (for example, red) that evokes danger.

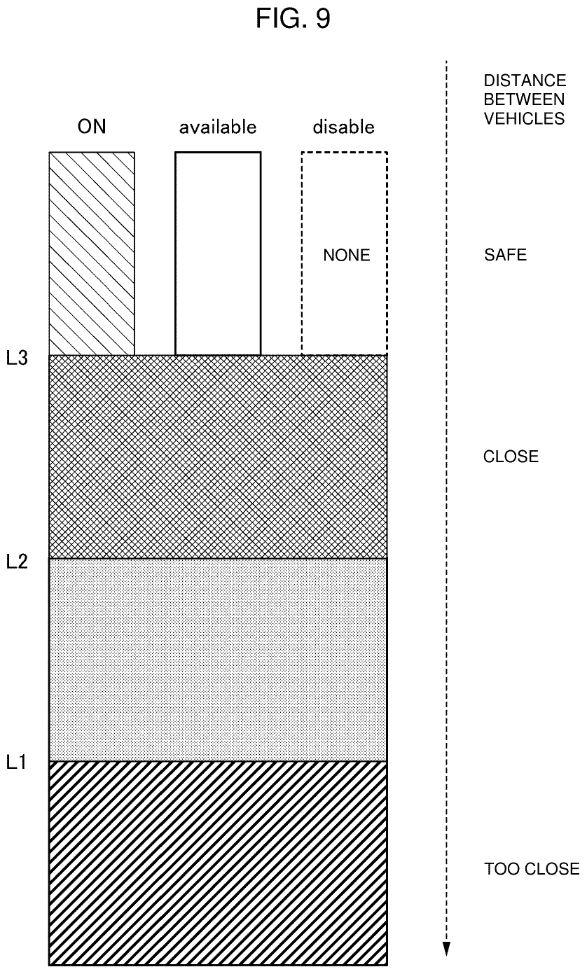

Here, an example of a relationship between distances between the own vehicle (for example, the vehicle 201) and other vehicles (for example, the vehicles 202 to 205) and the colors of outlines will be described with reference to FIG. 9. Note that FIG. 9 expresses a difference in color of the outlines by patterns.

For example, in a case where the distance between vehicles≥L3, a risk of the own vehicle coming into collision or contact with the other vehicle is extremely low, and thus, the color of the outline is set at green. Note that the density of the color (green) of the outline changes depending on the distance between vehicles. For example, as the distance between vehicles becomes greater, the color of the outline becomes lighter, and if the distance between vehicles becomes equal to or greater than a certain level of distance, the outline disappears.

For example, in a case where L2≤the distance between vehicles<L3, a risk of the own vehicle coming into collision or contact with the other vehicle is low, and thus, the color of the outline is set at yellow.

For example, in a case where L1≤the distance between vehicles<L2, a risk of the own vehicle coming into collision or contact with the other vehicle is medium, and thus, the color of the outline is set at orange.

For example, in a case where the distance between vehicles<L1, a risk of the own vehicle coming into collision or contact with the other vehicle is high, the color of the outline is set at red.

In this manner, the color of the outline for the other vehicle changes based on a degree of risk in accordance with the distance between the other vehicle and the own vehicle.

Note that, for example, in a case where a function of displaying the outline for the other vehicle is available but is turned off, the color of the outline is set at white regardless of the distance between vehicles.

For example, in a case where the function of displaying the outline for the other vehicle cannot be used, the outline is not displayed regardless of the distance between vehicles.

As described above, at least one of the shape or the color of the outline for the other vehicle changes based on a degree of risk of the own vehicle coming into contact with collision or contact with the other vehicle, and the degree of risk for the other vehicle is presented in an understandable manner.

For example, the other vehicle appears highlighted from the periphery by the outline, and thus, the driver can surely recognize existence of the other vehicle. Further, the driver can predict movement of the other vehicle based on change of the shape of the outline and can avoid collision or contact with the other vehicle. Still further, as a result of the color of the outline changing based on the degree of risk, it is possible to appropriately call attention for the other vehicle to the driver and avoid collision or contact with the other vehicle.

### <Display Example of Assistance Information for Pedestrian>

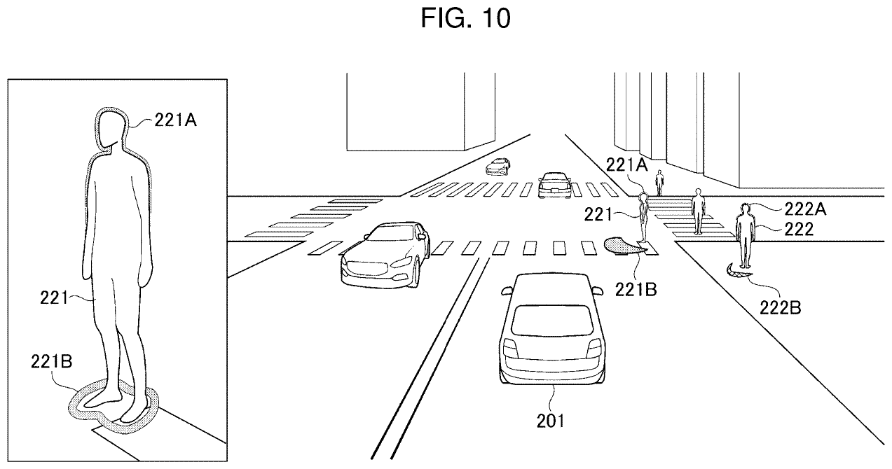

A display example of assistance information for a pedestrian will be described next with reference to FIG. 10. FIG. 10 schematically illustrates an example of the driving assistance image.

In the driving assistance image in FIG. 10, for example, assistance information is displayed for pedestrians located within a range of a predetermined distance in a traveling direction (for example, ahead) of the vehicle 201.

Specifically, for example, an outline 221A and an outline 221B are displayed for a pedestrian 221 who is crossing a crosswalk ahead of the vehicle 201 from right to left.

The outline 221A constitutes a contour of an upper body of the pedestrian 221.

The outline 221B is displayed on a road surface around the pedestrian 221. The outline 221B encloses a portion on a front and left side of the pedestrian 221 that is a portion close to the front surface (traveling direction) of the vehicle 201, that is, a portion with which the vehicle 201 is likely to come into collision or contact among a periphery of the pedestrian 221. Further, the pedestrian 221 is walking in a direction in which the pedestrian 221 cuts into ahead (traveling direction) of the vehicle 201, and thus, the outline 221B expands in the interrupting direction (ahead of the pedestrian 221).

Further, an outline 222A and an outline 222B are displayed for a pedestrian 222 who is walking on a pavement adjacent to a lane on which the vehicle 201 is traveling.

The outline 222A constitutes a contour of an upper body of the pedestrian 222.

The outline 222B is displayed on a road surface around the pedestrian 222. The outline 222B encloses a portion on the left side of the pedestrian 222 that is a portion close to the front surface (traveling direction) of the vehicle 201, that is, a portion with which the vehicle 201 is likely to come into collision or contact among a periphery of the pedestrian 222.

The colors of the outlines 221A to 222B change based on a degree of risk of the vehicle 201 coming into collision or contact with the pedestrian.

For example, in a case of this example, a degree of risk of the vehicle 201 coming into collision or contact with the pedestrian 221 is higher than a degree of risk of the vehicle 201 coming into collision or contact with the pedestrian 222.

Based on this, for example, the color of the outline 221A and the outline 221B for the pedestrian 221 is set at orange. For example, the color of the outline 222A and the outline 222B for the pedestrian 222 is set at yellow.

In this manner, one or both of the shape or the color of the outline for the pedestrian changes based on the degree of risk of the own vehicle coming into collision or contact with the pedestrian, and the degree of risk for the pedestrian is presented in an understandable manner. This makes it possible to appropriately call attention for the pedestrian to the driver, so that collision or contact with the pedestrian is avoided.

### <Display Examples of Assistance Information for Traffic Light>

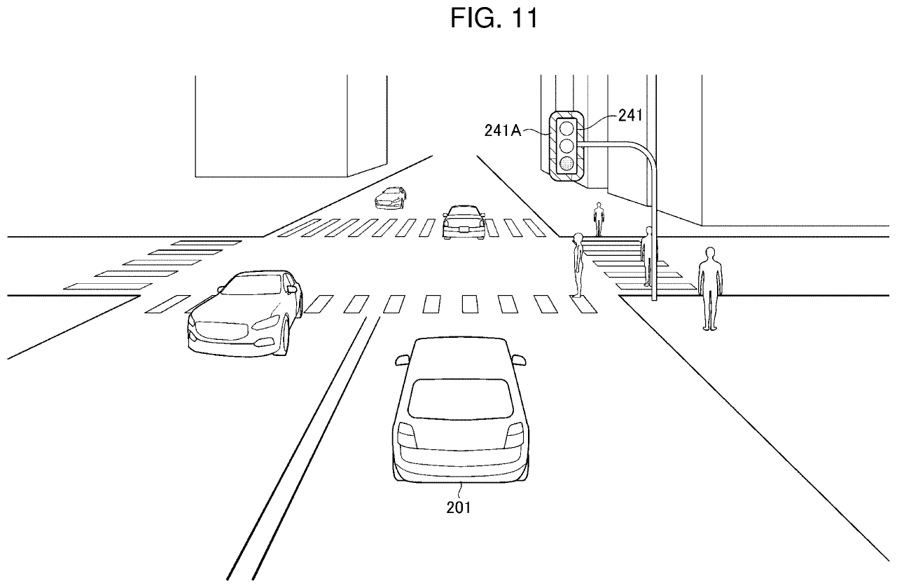

Display examples of assistance information for a traffic light will be described next with reference to FIG. 11 to FIG. 13. FIG. 11 to FIG. 13 schematically illustrate examples of the driving assistance image.

FIG. 11 illustrates a display example of the assistance information in a case where a traffic light 241 provided at an intersection ahead of the vehicle 201 is a green light.

In this case, an outline 241A that encloses a periphery of the traffic light 241 is displayed. For example, the color of the outline 241A is set to green that is the same color as the traffic light 241.

This enables the driver to surely recognize existence of the traffic light 241 and that the traffic light 241 is a green light.

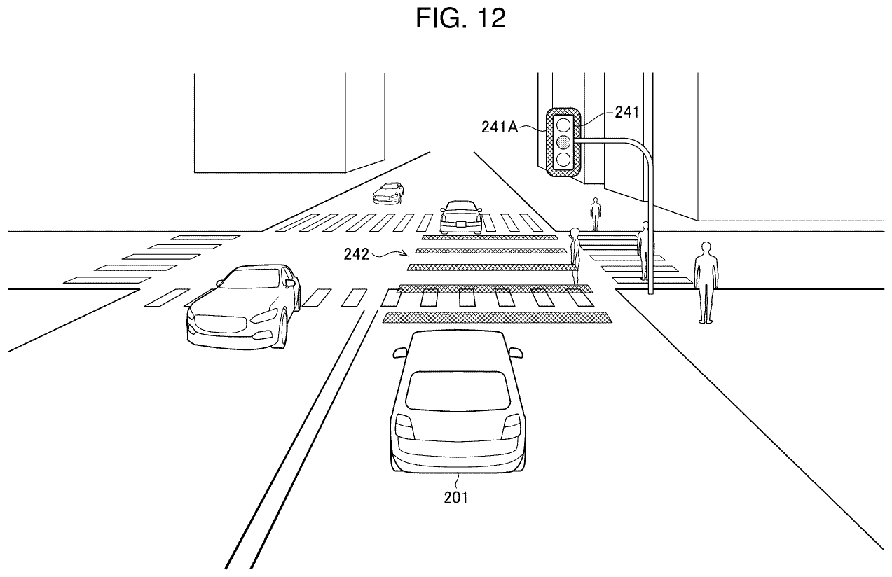

FIG. 12 illustrates a display example of the assistance information in a case where the traffic light 241 is a yellow light.

In this case, in a similar manner to the example of FIG. 11, the outline 241A that encloses the periphery of the traffic light 241 is displayed. The color of the outline 241A is set at yellow that is the same color as the traffic light 241.

Further, a speed reduction zone 242 that is a virtual object for reducing a speed of the vehicle 201 is displayed. The speed reduction zone 242 is displayed on the road surface so as to traverse the intersection ahead of the vehicle 201 longitudinally in the front-back direction within the lane on which the vehicle 201 is traveling. The speed reduction zone 242 includes a plurality of lines extending leftward and rightward, and the respective lines are arranged at a predetermined interval in the front-back direction. The color of each line is, for example, set at yellow that is the same color as the traffic light 241.

This enables the driver to surely recognize existence of the traffic light 241 and that the traffic light 241 is a yellow light. Further, the speed reduction zone 242 encourages the driver to reduce (decelerate) an approaching speed to the intersection.

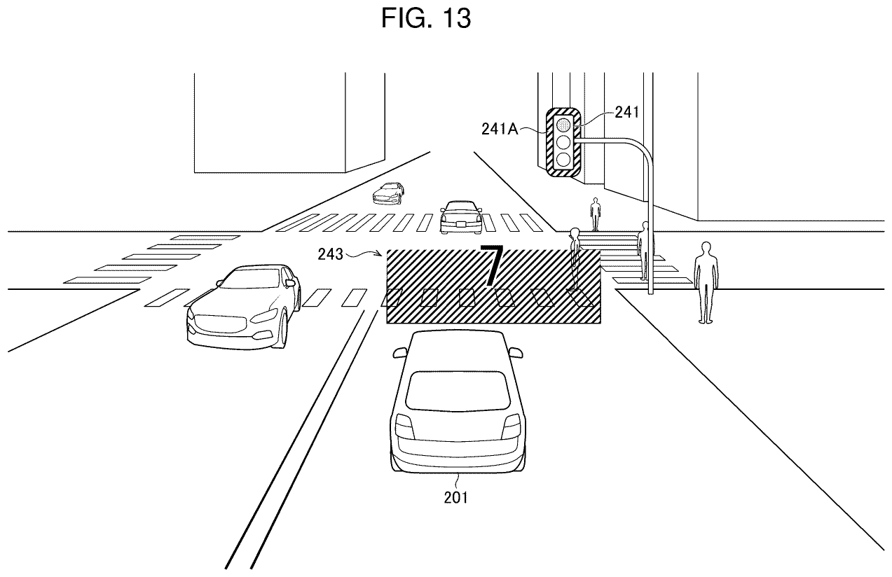

FIG. 13 illustrates a display example of the assistance information in a case where the traffic light 241 is a red light.

In this case, in a similar manner to the example in FIG. 11 and FIG. 12, the outline 241A that encloses the periphery of the traffic light 241 is displayed. The color of the outline 241A is, for example, set to red that is the same color as the traffic light 241.

Further, a wall 243 that is a virtual object for preventing the vehicle 201 from traveling, that is, preventing the vehicle 201 from entering the intersection is displayed. The wall 243 is displayed so as to be grounded on the road surface and extend in a vertical direction from a position of the line on the near side (closest to the vehicle 201) among the lines of the speed reduction zone 242 in FIG. 12. Further, waiting time of the red light of the traffic light 241 is displayed on the wall 243. The color of the wall 243 is, for example, set to red that is the same color as the traffic light 241.

This enables the driver to surely recognize existence of the traffic light 241 and that the traffic light 241 is a red light. Further, the wall 243 encourages the driver to stop in front of the intersection and not to enter the intersection. Still further, the driver can know the waiting time of the red light.

### <Display Example of Assistance Information Regarding Accident Risk Point>

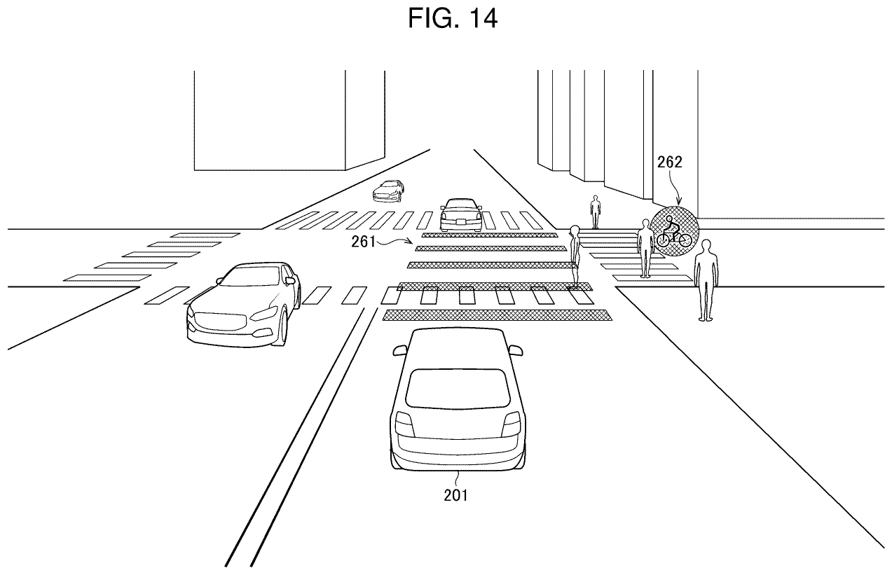

A display example of assistance information regarding an accident risk point such as an intersection without a traffic light will be described next with reference to FIG. 14. The accident risk point is, for example, a point at which a dangerous event such as an accident occurred in the past or a point at which an accident is likely to occur and is a point at which the driver particularly requires to pay attention. FIG. 14 schematically illustrates an example of the driving assistance image.

For example, the image generation section 181 detects an accident risk point based on map information, or the like, and generates a driving assistance image including assistance information for the detected accident risk point.

FIG. 14 illustrates a display example of the assistance information in a case where the vehicle 201 reaches in front of an intersection without a traffic light which is the accident risk point.

For example, a speed reduction zone 261 that is similar to the speed reduction zone 242 in FIG. 12 is displayed on a road surface so as to traverse the intersection ahead of the vehicle 201 longitudinally in the front-back direction on the lane on which the vehicle 201 is traveling.

Further, an icon 262 that is a virtual object indicating a person on a bicycle is displayed so as to be grounded on a road surface of a road extending rightward from the intersection. For example, the icon 262 is displayed so as to call attention for rushing out to the driver regardless whether or not there is a bicycle.

This enables the driver to surely recognize an accident risk point and pay attention for rushing out, and the like.

### <Display Example of Assistance Information for Course of Vehicle>

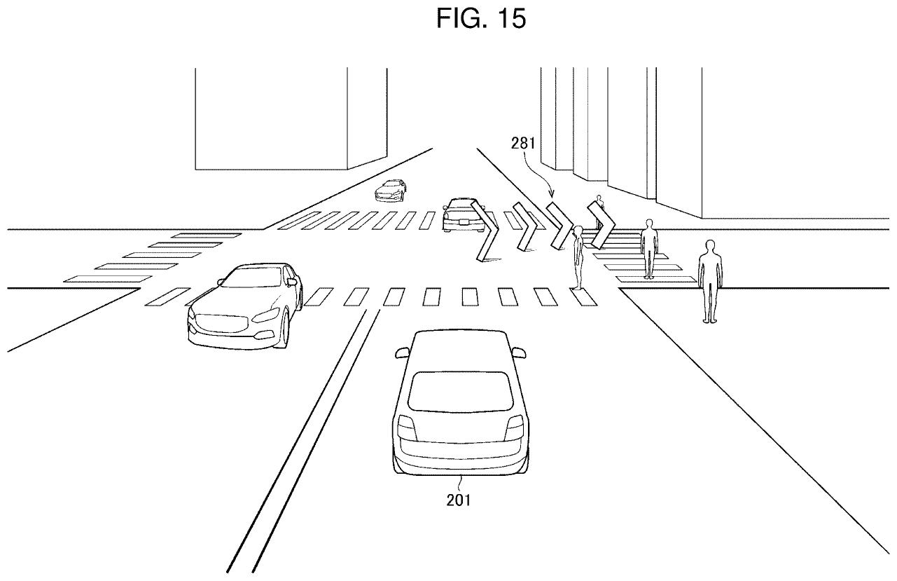

A display example of assistance information for a course of the vehicle 201 will be described next with reference to FIG. 15 to FIG. 17. FIG. 15 to FIG. 17 schematically illustrate an example of the driving assistance image.

Note that the course of the vehicle 201 is set, for example, based on map information, and the like, included in the external information.

FIG. 15 to FIG. 17 illustrate examples in a case where the course of the vehicle 201 turns right at the intersection in front of the vehicle 201.

In the driving assistance image in FIG. 15, assistance information 281 indicating the course of the vehicle 201 is displayed at the intersection in front of the vehicle 201.

The assistance information 281 includes a plurality of virtual objects that expresses the course of the vehicle 201 with arrows. The respective virtual objects are grounded so as to stand on the road surface within the intersection in front of the vehicle 201 on the lane on which the vehicle 201 is traveling and arranged in a right-turning direction. A shadow is displayed at a lower end of each virtual object so as to emphasize that each virtual object is grounded.

In this manner, as a result of each virtual object of the assistance information 281 being grounded, a positional relationship between the assistance information 281 and the intersection becomes clear, and it becomes easier to understand a position at which the vehicle 201 turns right. This, for example, enables the driver to surely turn right at the intersection in front of the vehicle 201 without taking a wrong course.

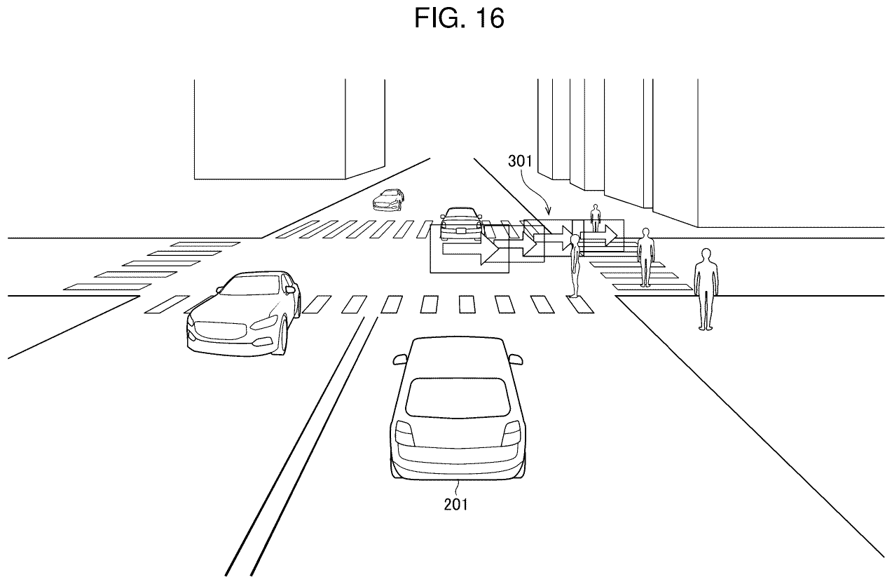

In the driving assistance image in FIG. 16, assistance information 301 indicating the course of the vehicle 201 is displayed at the intersection in front of the vehicle 201.

The assistance information 301 includes a plurality of virtual objects using as motif, a plurality of arrow boards indicating a traveling direction provided at a construction site, or the like. The respective virtual objects are grounded so as to stand on the road surface within the intersection in front of the vehicle 201 on the lane on which the vehicle 201 is traveling and are arranged so as to overlap with each other along the right-turning direction.

In this manner, as a result of each virtual object of the assistance information 301 being grounded, a positional relationship between the assistance information 301 and the intersection becomes clear, and it becomes easier to understand the position at which the vehicle 201 turns right. This, for example, enables the driver to surely turn right at the intersection in front of the vehicle 201 without taking a wrong course.

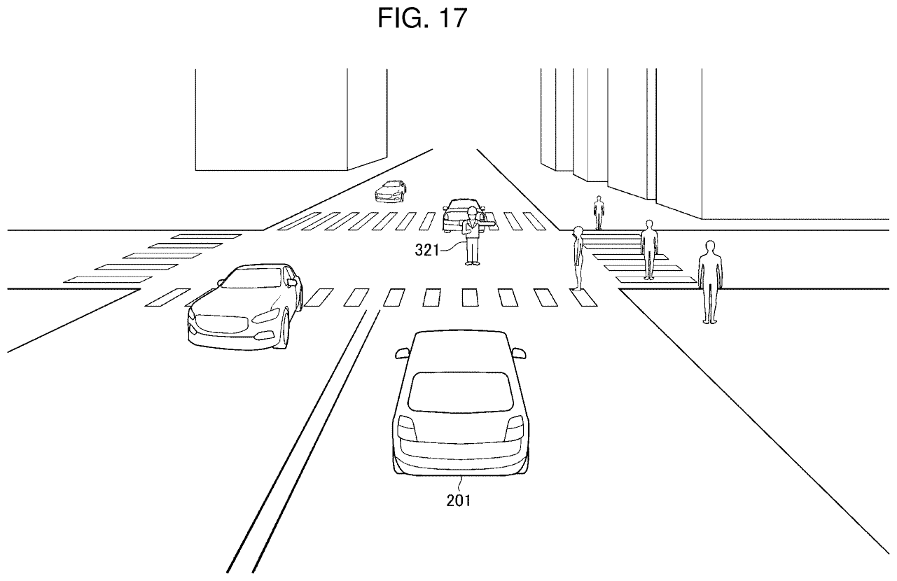

In the driving assistance image in FIG. 17, a guide 321 that is a virtual object indicating the course of the vehicle 201 is displayed at the intersection in front of the vehicle 201.

The guide 321 is grounded so as to stand on the road surface within the intersection in front of the vehicle 201 on the lane on which the vehicle 201 is traveling. Further, the guide 321 indicates the course of the vehicle 201 by gesture.

In this manner, as a result of the guide 321 being grounded, a positional relationship between the guide 321 and the intersection becomes clear, and it becomes easier to understand the position at which the vehicle 201 turns right. This, for example, enables the driver to surely turn right at the intersection in front of the vehicle 201 without taking a wrong course.

As described above, the content of driving assistance is presented in an understandable manner by the assistance information within the driving assistance image. This enables the driver to accurately recognize the content of the driving assistance and appropriately act in accordance with the driving assistance.

### 2. Modifications

Modifications of the above-described embodiment of the present technology will be described below.

### <Modification Regarding Driving Assistance Image>

For example, the driving assistance image may include an image indicating a state of a periphery other than a portion ahead of the vehicle 1. For example, in a case where the vehicle 1 moves backward, the driving assistance image may include an image indicating a state of a portion backward of the vehicle 1.

For example, objects for which outlines are to be displayed are not limited to other vehicles or pedestrians described above. For example, outlines may be displayed for other mobile objects such as bicycles, or outlines may be displayed for stationary objects such as obstacles.

For example, a degree of risk of the own vehicle coming into collision or contact with the object may be calculated based on other elements in addition to or in place of a relative distance to the own vehicle, and a display aspect of the assistance information (for example, the color and shape) may change based on the degree of risk. Examples of such elements can include a relative speed, and the like. Further, for example, a degree of risk may be calculated based on the content of functions (for example, an advanced driver assistance system (ADAS)) of the vehicle 1, whether or not the functions are operating, or the like.

For example, in a case where the vehicle 1 is traveling at a location other than the road, the assistance information may be grounded or displayed on the ground other than the road surface.

While an example has been described above where the driving assistance image is generated by CG, for example, the driving assistance image may be generated by the assistance information being superimposed on a captured image of the periphery of the vehicle 1.

### <Other Modifications>

A position of a display that displays the driving assistance image is not necessarily limited to the above-described example. For example, the driving assistance image may be displayed on the display 111R, the display 112L, the display 112R or the display 113. For example, the driving assistance image may be displayed so as to be continuous on the display 111L and the display 112R.

A configuration example of the display of the display unit 75 can be changed as appropriate. For example, the display 111L and the display 111R may be connected to constitute one display. For example, the display 111R may be divided into two displays of a display in front of a portion between the driver's seat and the front passenger's seat and a display in front of the front passenger's seat.

The present technology can be applied to a mobile object traveling on a road other than a vehicle.

### 3. Others

### <Configuration Example of Computer>

The above-described series of processing can be executed by hardware or can be executed by software. In a case where a series of processing is executed by software, a program constituting the software is installed on a computer. Here, the computer includes a computer incorporated into dedicated hardware, a computer capable of executing various kinds of functions by various kinds of programs being installed, for example, a general-purpose personal computer, and the like.

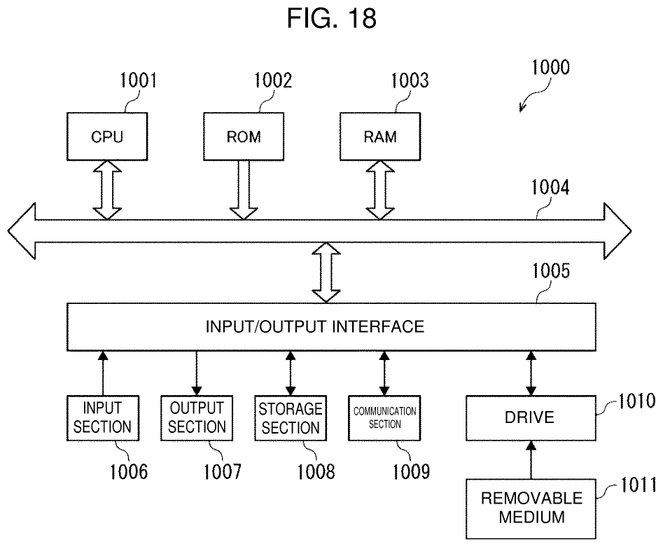

FIG. 18 is a block diagram illustrating a configuration example of hardware of a computer that executes the above-described series of processing by a program.

In a computer 1000, a central processing unit (CPU) 1001, a read only memory (ROM) 1002, and a random access memory (RAM) 1003 are connected to each other by a bus 1004.

An input/output interface 1005 is further connected to the bus 1004. An input section 1006, an output section 1007, a storage section 1008, a communication section 1009, and a drive 1010 are connected to the input/output interface 1005.

The input section 1006 includes an input switch, a button, a microphone, an imaging element, and the like. The output section 1007 includes a display, a speaker, and the like. The storage section 1008 includes a hard disk, a non-volatile memory, and the like. The communication section 1009 includes a network interface, and the like. The drive 1010 drives a removable medium 1011 such as a magnetic disk, an optical disk, a magnetooptical disk or a semiconductor memory.

In the computer 1000 configured as described above, the above-described series of processing is executed by the CPU 1001 loading a program, for example, stored in the storage section 1008 to the RAM 1003 via the input/output interface 1005 and the bus 1004 and executing the program.

The program to be executed by the computer 1000 (CPU 1001) can be provided by being recorded in the removable medium 1011, for example, as a package medium. Further, the program can be provided via a wired or wireless transmission medium such as a local area network, the Internet and digital satellite broadcasting.

In the computer 1000, the program can be installed on the storage section 1008 via the input/output interface 1005 by the removable medium 1011 being loaded to the drive 1010. Further, the program can be received at the communication section 1009 via a wired or wireless transmission medium and can be installed on the storage section 1008. In addition, the program can be installed in advance on the ROM 1002 or the storage section 1008.

Note that the program to be executed by the computer may be a program in which processing is performed in chronological order along the order described in the present specification or may be a program in which processing is performed in parallel or at a necessary timing such as when calling is performed.

Further, in the present specification, the system means an aggregate of a plurality of components (such as an apparatus and a module (part)) regardless of whether or not all the components are within the same chassis. Thus, both a plurality of apparatuses accommodated in different chassis and connected via a network and one apparatus in which a plurality of modules is accommodated in one chassis are systems.

Further, the embodiment of the present technology is not limited to the above-described embodiment and can be modified in various manners within a range not deviating from the gist of the present technology.

For example, the present technology can take a configuration of cloud computing in which a plurality of apparatuses shares and performs one function in cooperation via a network.

Further, the respective steps described in the above-described flowchart can be shared and executed by a plurality of apparatuses as well as being executed by one apparatus.

Still further, in a case where one step includes a plurality of kinds of processing, the plurality of kinds of processing included in the one step can be shared and executed by a plurality of apparatuses as well as being executed by one apparatus.

### <Examples of Combinations of Configurations>

The present technology can take the following configurations.

(1) An information processing apparatus including a display control section that controls display of a driving assistance image obtained by adding, to an image indicating a state of a periphery of a vehicle, assistance information that is added to an object within the image and assists driving, and controls a color and a shape of the assistance information based on a state of the object with respect to the vehicle.

(2) The information processing apparatus according to (1), in which the assistance information includes an outline that encloses at least part of a periphery of the object.

(3) The information processing apparatus according to (2), in which the outline encloses at least part of the periphery of the object on a ground around the object.

(4) The information processing apparatus according to (3), in which the display control section controls a shape of the outline based on a moving direction of the object with respect to the vehicle.

(5) The information processing apparatus according to (4), in which in a case where the object moves in an interrupting direction in which the object cuts into a traveling direction of the vehicle, the display control section expands the outline in the interrupting direction.

(6) The information processing apparatus according to any of (3) to (5), in which the outline encloses a portion close to the vehicle, of the object.

(7) The information processing apparatus according to any of (1) to (6), in which the display control section controls at least one of the color or the shape of the assistance information based on a degree of risk of the object coming into collision or contact with the vehicle.

(8) The information processing apparatus according to (7), in which the degree of risk is based on a distance between the vehicle and the object.

(9) The information processing apparatus according to any of (1) to (8),
in which the display control section generates the driving assistance image by computer graphics, and
the driving assistance image includes an image of the vehicle.

(10) An information processing method including
an information processing apparatus controlling display of a driving assistance image obtained by adding, to an image indicating a state of a periphery of a vehicle, assistance information for an object around the vehicle, and
controlling a color and a shape of the assistance information based on a state of the object with respect to the vehicle.

(11) An information processing apparatus including a display control section that controls display of a driving assistance image obtained by adding, to an image indicating a state of a periphery of a vehicle, assistance information grounded or displayed on a ground for assisting driving.

(12) The information processing apparatus according to (11), in which the assistance information includes a virtual object grounded or displayed on the ground for reducing a speed or preventing traveling of the vehicle.

(13) The information processing apparatus according to (12), in which the virtual object is used to prevent entry or reduce an approaching speed to an intersection.

(14) The information processing apparatus according to (13), in which the display control section adapts a color of the virtual object to a color of a traffic light provided at the intersection.

(15) The information processing apparatus according to (14),
in which the assistance information includes an outline that encloses at least part of a periphery of the traffic light, and
the display control section adapts a color of the outline to the color of the traffic light.

(16) The information processing apparatus according to any of (11) to (15), in which the assistance information includes a virtual object grounded on the ground in a traveling direction of the vehicle and indicating a course of the vehicle.

(17) The information processing apparatus according to (16), in which the assistance information includes a shadow of the virtual object displayed on the ground.

(18) The information processing apparatus according to (16) or (17), in which the virtual object is grounded on the ground within a lane on which the vehicle is traveling within an intersection located in the traveling direction.

(19) The information processing apparatus according to any of (11) to (18),
in which the display control section generates the driving assistance image by computer graphics, and
the driving assistance image includes an image of the vehicle.

(20) An information processing method including an information processing apparatus controlling display of a driving assistance image obtained by adding, to an image indicating a state of a periphery of a vehicle, assistance information grounded or displayed on a ground within the image for assisting driving.

Note that the effects described in the present specification are merely examples, the effects are not limited to the described effects and may include other effects.

### REFERENCE SIGNS LIST

1 Vehicle
11 Vehicle control system
21 Control unit
22 External sensor
23 GNSS receiver
24 In-vehicle sensor
Vehicle sensor
28 Display section
41 Camera
75 Display unit
111L to 113 Display
151 Information acquisition section
153 Display control section
161 Detection section
162 Own position estimation section
163 External information collection section
171 External state detection section
172 Vehicle state detection section
173 Occupant state detection section
181 Image generation section
182 Output control section

1. An information processing apparatus comprising a display control section that controls display of a driving assistance image obtained by adding, to an image indicating a state of a periphery of a vehicle, assistance information that is added to an object within the image and assists driving, and controls a color and a shape of the assistance information based on a state of the object with respect to the vehicle.

2. The information processing apparatus according to claim 1, wherein the assistance information includes an outline that encloses at least part of a periphery of the object.

3. The information processing apparatus according to claim 2, wherein the outline encloses at least part of the periphery of the object on a ground around the object.

4. The information processing apparatus according to claim 3, wherein the display control section controls a shape of the outline based on a moving direction of the object with respect to the vehicle.

5. The information processing apparatus according to claim 4, wherein in a case where the object moves in an interrupting direction in which the object cuts into a traveling direction of the vehicle, the display control section expands the outline in the interrupting direction.

6. The information processing apparatus according to claim 3, wherein the outline encloses a portion close to the vehicle, of the object.

7. The information processing apparatus according to claim 1, wherein the display control section controls at least one of the color or the shape of the assistance information based on a degree of risk of the object coming into collision or contact with the vehicle.

8. The information processing apparatus according to claim 7, wherein the degree of risk is based on a distance between the vehicle and the object.

9. The information processing apparatus according to claim 1, wherein
the display control section generates the driving assistance image by computer graphics, and
the driving assistance image includes an image of the vehicle.

10. An information processing method comprising:
an information processing apparatus controlling display of a driving assistance image obtained by adding, to an image indicating a state of a periphery of a vehicle, assistance information for an object around the vehicle; and
controlling a color and a shape of the assistance information based on a state of the object with respect to the vehicle.

11. An information processing apparatus comprising a display control section that controls display of a driving assistance image obtained by adding, to an image indicating a state of a periphery of a vehicle, assistance information grounded or displayed on a ground for assisting driving.

12. The information processing apparatus according to claim 11, wherein the assistance information includes a virtual object grounded or displayed on the ground for reducing a speed or preventing traveling of the vehicle.

13. The information processing apparatus according to claim 12, wherein the virtual object is used to prevent entry or reduce an approaching speed to an intersection.

14. The information processing apparatus according to claim 13, wherein the display control section adapts a color of the virtual object to a color of a traffic light provided at the intersection.

15. The information processing apparatus according to claim 14, wherein
the assistance information includes an outline that encloses at least part of a periphery of the traffic light, and
the display control section adapts a color of the outline to the color of the traffic light.

16. The information processing apparatus according to claim 11, wherein the assistance information includes a virtual object grounded on the ground in a traveling direction of the vehicle and indicating a course of the vehicle.

17. The information processing apparatus according to claim 16, wherein the assistance information includes a shadow of the virtual object displayed on the ground.

18. The information processing apparatus according to claim 16, wherein the virtual object is grounded on the ground within a lane on which the vehicle is traveling within an intersection located in the traveling direction.

19. The information processing apparatus according to claim 11, wherein
the display control section generates the driving assistance image by computer graphics, and
the driving assistance image includes an image of the vehicle.

20. An information processing method comprising an information processing apparatus controlling display of a driving assistance image obtained by adding, to an image indicating a state of a periphery of a vehicle, assistance information grounded or displayed on a ground within the image for assisting driving.
